(19) United States
(12) Patent Application Publication
(10) Pub. No.: US 2009/0130373 A1
(43) Pub. Date: May 21, 2009

(54) Non-skid, fabric bordered doormat and method for manufacturing same

(75) Inventor: Nadav Sharir, Raleigh, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Glenoit LLC

(21) Appl. No.: 11/986,132

(22) Filed: Nov. 20, 2007

(51) Int. Cl. B32B 3/02; B05D 3/02; B32B 33/00

(52) U.S. Cl. 428/95; 427/389.9; 428/193

(57) ABSTRACT

The doormat is fabricated from a sheet of material. An integral non-skid latex backing layer is formed on the rear surface of the material sheet. The backed material sheet forms the central section of the doormat. A separate fabric border is fabricated with mitered corners. The fabric border is folded around the edge of the backed central section and the folded fabric border is stitched to the central section. The backing layer is composed from latex foam. The foam is formed from liquid latex obtained by combining water and a solid mix comprising natural rubber with soap, filler, a thickening agent and an accelerator and then mixing the liquid latex with air. The foam is sprayed on the rear surface of the material sheet and then cured by heating the foam layer with steam and exposure to infra-red radiation to form a paste layer. The paste layer is then embossed and dried.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

1. Field of the Invention

The present invention relates to doormats and more particularly a non-skid, fabric bordered doormat and a method for manufacturing same.

2. Description of Prior Art Including Information Disclosed Under 37 CFR 1.97 and 1.98

Many products, including chair pads, placemats and rugs include a high friction backing layer to provide a non-skid or skid resistant property. In most instances, the non-skid backing is created by attaching a separate sheet of flexible fabric or latex material to the undersurface by adhesive or other conventional methods.

Further, carpets, rugs and doormats are known to have a central section surrounded by a visually different border to enhance the appearance thereof. The border can be created as the article is fabricated, it can be created by dying the border a different color than the central portion after the article is fabricated or it can be created by forming the border and central portion as separate parts and than joining the parts together or attaching the part to a common flexible sheet by adhesive.

However, it is not known to fabricate a non-skid doormat by creating the central portion with an integral latex non-skid backing layer and then framing the backed central portion with a separately fabricated border with mitered corners by folding the border around the edges of the central portion and then sewing the border to the central portion.

It is therefore a prime object of the present invention to provide a non-skid doormat with an aesthetically pleasing fabric border having mitered corners.

It is another object of the present invention to provide a method for manufacturing a non-skid doormat with a mitered corner fabric border.

It is another object of the present invention to provide a method for manufacturing a non-skid, fabric bordered doormat wherein the central portion is fabricated with an integral non-skid backing layer.

It is another object of the present invention to provide a method for manufacturing a non-skid, fabric bordered doormat wherein the fabric border is fabricated with mitered corners and then attached to the backed central portion.

It is another object of the present invention to provide a method for manufacturing a non-skid, fabric bordered doormat wherein a layer of foam material is applied to the underside of the central portion and then cured to form an integral non-skid layer.

It is another object of the present invention to provide a method for manufacturing a non-skid, fabric bordered doormat wherein the foam material is prepared by mixing liquid latex with air.

It is another object of the present invention to provide a method for manufacturing a non-skid, fabric bordered doormat wherein the foam layer is cured by steam and infra-red radiation to form a paste.

It is another object of the present invention to provide a method for manufacturing a non-skid, fabric bordered doormat wherein the paste is embossed to enhance the non-skid properties thereof.

It is another object of the present invention to provide a method for manufacturing a non-skid, fabric bordered doormat wherein the border is folder around the edges of the backed central portion and attached thereto by stitching.

### BRIEF SUMMARY OF THE INVENTION

In accordance with one aspect of the present invention, a method is provided for fabricating a doormat. The method includes the steps of:
(a) forming a sheet of material;
(b) forming an integral non-skid latex backing layer on the rear surface of the material sheet;
(c) cutting the backed material sheet to form a central section;
(d) forming a separate fabric border with mitered corners;
(e) folding the fabric border around the edge of the backed central section; and
(f) stitching the folded fabric border to the central section.

The step of forming the backing layer includes the steps of:
(g) creating latex foam;
(h) spraying a layer of the foam on the rear surface of the material sheet; and
(i) curing the foam layer.

The step of curing the foam layer includes the step of heating the foam layer to form a paste layer.

The step of heating the foam layer includes the steps of applying steam to the foam layer and exposing the foam layer to infra-red radiation.

The step of creating latex foam includes the steps of:
(j) creating liquid latex by combining water and a solid mix comprising natural rubber with soap, filler, a thickening agent and an accelerator; and
(k) mixing the liquid latex with air.

The step of forming the backing layer also includes the steps of:
(k) embossing the paste layer; and
(l) drying the embossed paste layer.

The step of forming a separate fabric border with mitered corners includes the steps of:
(p) cutting a fabric sheet into strips;
(q) mitering the ends of the strips; and
(r) sewing the mitered ends of the strips together.

The step of cutting the backed material sheet includes the step of cutting the backed material sheet to form a central section having the shape of, but somewhat small size than, the doormat.

In accordance with another aspect of the present invention, a non-skid doormat is provided including a central section with a rear surface and an edge. The rear surface has an integral non-skid layer. The integral non-skid layer is formed of cured latex foam. A fabric border with mitered corners is provided. Means are provided for attaching the fabric border to the central section proximate the edge thereof.

The non-skid layer is formed of a paste of cured latex foam. The paste is preferably embossed. The embossed paste is cured.

The cured latex foam layer includes liquid latex mixed with air. The liquid latex comprises natural rubber, soap, filler, a thickening agent and an accelerator.

The fabric border with mitered corners includes first and second fabric strips with mitered ends. Means are provided for stitching the mitered ends together.

The attaching means includes a plurality of stitches.

The fabric border has a folded portion defining a recess. The edge of the central portion is received in the recess.

The central section is preferably formed of carpet material.

### BRIEF DESCRIPTION OF THE SEVERAL VIEWS OF DRAWINGS

To these and to such other objects that may hereinafter appears, the present invention relates to a non-skid, fabric bordered doormat and method for manufacturing same as described in detail in the following specification and recited in the annexed claims, taken together with the accompanying drawings, in which like numerals refer to like parts and in which:

FIG. 1 is a perspective view of the doormat of the present invention as it would appear on a floor;

FIG. 2 is a perspective view showing the underside of the doormat;

FIG. 3 is a cross-sectional view taken along line 3-3 of FIG. 2;

FIG. 4 is an idealized representation of the process for fabricating the central section of the doormat with the integral non-skid surface;

FIG. 5 is an exploded perspective view of the central section and the fabric border prior to the fabric border being attached to the central portion;

FIG. 6 is a perspective view of an edge of the central section showing the fabric border being folded around the edge and the top portion thereof being sewn in place; and

FIG. 7 is a view similar to FIG. 6 showing the bottom of the fabric border being sewn in place.

### DETAIL DESCRIPTION OF THE INVENTION

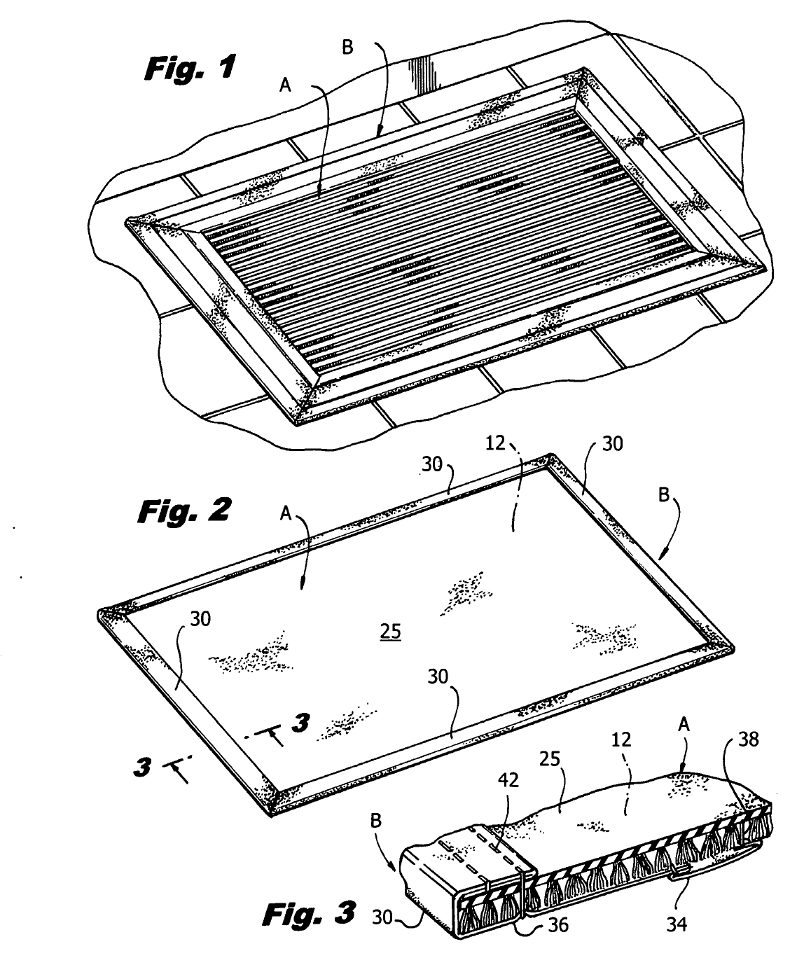

The doormat of the present invention is shown in perspective in FIG. 1. It includes a central section with an integral non-skid rear surface, generally designated A, made from any flexible sheet material, such as rubber, plastic, fabric or carpet material. The doormat additionally includes a fabric frame or border, generally designated B, attached to the edge of and surrounding central section A.

FIG. 4 illustrates the process for fabricating the central section A with the integral non-skid rear surface. Roll 10 represents the source of the sheet material 12 from which the central section A of the doormat will be formed. Material 12 is removed from roll 10 and passes through a first station 14 where latex foam 16 is deposited on the rear surface of the sheet material.

Latex foam 16 is obtained by creating liquid latex by combining water and a solid mix comprising natural rubber with soap, filler, a thickening agent and an accelerator. The liquid latex is then mixed with air and sprayed onto the rear surface of the sheet material 12.

The sheet material 12 with the latex foam layer is moved to a curing station 18 where to foam is heated to form a paste 20. The heating process involves the application of steam and exposing the foam to infra-red radiation.

The cured paste then passes between embossing rollers 22, 24 which give the surface of the paste a texture to enhance the high friction attributes of the non-skid surface. The embossed paste layer is allowed to dry to form the non-skid layer 25 and then the sheet material 12 is moved into the cutting station 26 and beneath a reciprocating press 28 which die-cuts the sheet material into a central section A with a shape and size suitable for the doormat.

The fabric border B is fabricated separately. Fabric border B consists if four fabric strips 30 cut from a fabric sheet. The ends of each strip 30 are cut at an angle, preferably 45 degrees, and then sewn together to form a frame or border 32 as illustrated in FIG. 5. Border 32 has a central opening that is somewhat smaller that the size of central section A. Preferably, border 32 is formed of two portions, an inner portion 34 and an outer portion 36, for aesthetic reasons. The inner and outer portions 34, 36 of border 32 may be made of different materials, have different colors or different textures.

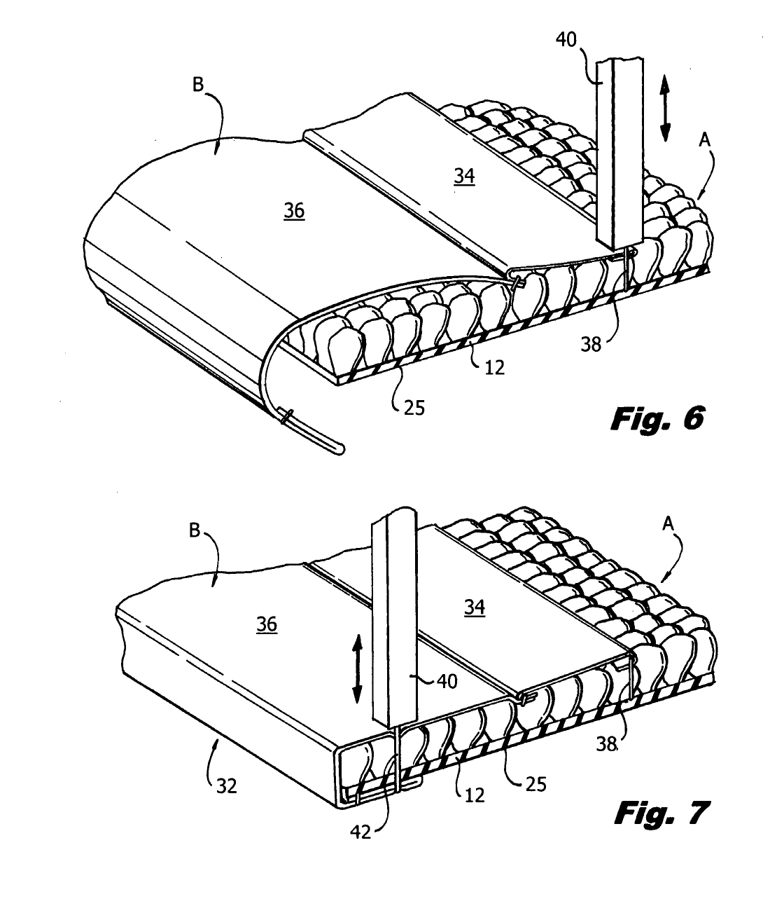

FIGS. 6 and 7 illustrate the process of attaching the central section A and the border B. As shown in FIG. 6, border B is placed over central section A and the inner edge of portion 34 is sewn to central section A with stitches 38 using a sewing machine 40, only a portion of which is illustrated. Once the inner edge of portion 34 is attached to central section A, the outer section of portion 36 is folded around the edge of central section A so as to form a recess into which the edge of central section A is received, as shown in FIG. 6. Portion 36 of border B is then sewn in place with stitches 42, by sewing machine 40, as shown in FIG. 7.

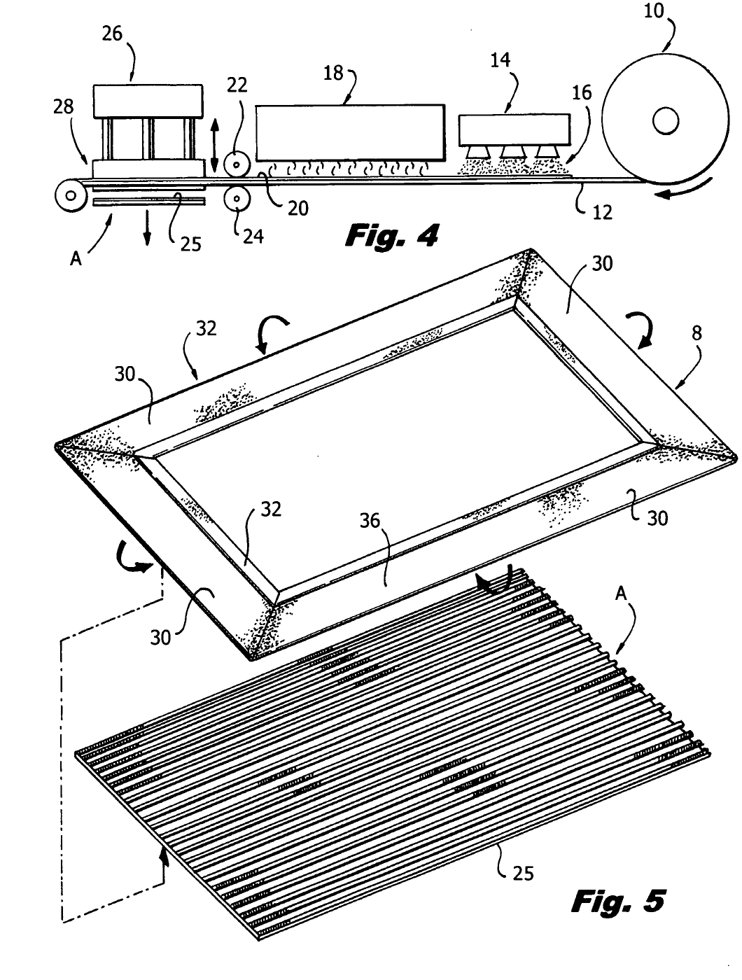

FIGS. 2 and 3 show the undersurface of the completed product, and a cross-section view of the doormat, respectively. The doormat includes a central section A with a rear surface and an edge. The rear surface has an integral non-skid layer 25. The integral non-skid layer 25 is formed of cured latex foam 16. A fabric border B with mitered corners is fabricated separately. The fabric border B is attached to the central section A by stitching lines 38 and 42 proximate the edge thereof.

The non-skid layer 25 is formed of a paste 20 of cured latex foam 16. Paste 20 is preferably embossed. The embossed paste is dried to form layer 25.

The latex foam 16 includes liquid latex mixed with air. The liquid latex comprises natural rubber, soap, filler, a thickening agent and an accelerator.

The fabric border A with mitered corners includes multiple fabric strips 30 with mitered ends. The mitered ends of strips 30 are stitched together to form border B.

The fabric border is folded to define a recess. The edge of central portion A is received in the recess. The border B is attached to central section A by stitching.

It will now be appreciated that the present invention relates to a doormat with an integral non-skid rear surface and a fabric border. The non-skid surface is formed of a cured latex foam paste which is embossed to increase the high friction properties of the surface. The border is fabricated separately from the central section by stitching the mitered ends of fabric strips together. The border is then folded around the edge of the central section and stitched to the central section to form the product.

While only a single preferred embodiment of the present invention has been disclosed for purposes of illustration, it is obvious that many modifications and variations could be made thereto. It is intended to cover all of those modifications and variations which fall within the scope of the present invention, as defined by the following claims.

I claim:

1. A method for fabricating a doormat comprising the steps of:
(a) forming a sheet of material;
(b) forming an integral non-skid latex backing layer on the rear surface of the material sheet;
(c) cutting the backed material sheet to form a central section;
(d) forming a separate fabric border with mitered corners;
(e) folding the fabric border around the edge of the backed central section; and
(f) stitching the folded fabric border to the central section.

2. The method of claim 1 wherein the step of forming the backing layer comprises the steps of:
(g) creating latex foam;
(h) spraying a layer of the foam on the rear surface of the material sheet; and
(i) curing the foam layer.

3. The method of claim 2 wherein the step of curing the foam layer comprises the step of heating the foam layer to form a paste layer.

4. The method of claim 3 wherein the step of heating the foam layer comprises the step of applying steam to the foam layer.

5. The method of claim 3 wherein the step of heating the foam layer comprises the step of exposing the foam layer to infra-red radiation.

6. The method of claim 2 wherein the step of creating latex foam comprises the steps of:
(j) creating liquid latex by combining water and a solid mix comprising natural rubber with soap, filler, a thickening agent and an accelerator; and
(k) mixing the liquid latex with air.

7. The method of claim 3 wherein the step of forming the backing layer further comprises the steps of:
(k) embossing the paste layer; and
(l) drying the embossed paste layer.

8. The method of claim 1 wherein the step of forming a separate fabric border with mitered corners comprises the steps of:
(p) cutting a fabric sheet into strips;
(q) mitering the ends of the strips; and
(r) sewing the mitered ends of the strips together.

9. The method of claim 1 wherein the step of cutting the backed material sheet comprises the step of cutting the backed material sheet to form a central section having the shape of, but somewhat small size than, the doormat.

10. A non-skid doormat comprising a central section with a rear surface and an edge, said rear surface comprising an integral non-skid layer, said integral non-skid layer comprising cured latex foam, a fabric border with mitered corners, and means for attaching said fabric border to said central section proximate said edge.

11. The doormat of claim 10 wherein said layer comprises a paste of cured latex foam.

12. The doormat of claim 11 wherein said paste is embossed.

13. The doormat of claim 12 wherein said embossed paste is cured.

14. The doormat of claim 10 wherein said cured latex foam layer comprises liquid latex mixed with air.

15. The doormat of claim 14 wherein said liquid latex comprises natural rubber, soap, filler, a thickening agent and an accelerator.

16. The doormat of claim 10 wherein said fabric border with mitered corners comprises first and second fabric strips with mitered ends and means for stitching said mitered ends together.

17. The doormat of claim 10 wherein said attaching means comprises a plurality of stitches.

18. The doormat of claim 10 wherein said fabric border comprises a folded portion defining a recess.

19. The doormat of claim 18 wherein said edge of said central portion is received in said recess.

20. The doormat of claim 10 wherein said central section comprises carpet material.
